(19) United States
(12) Patent Application Publication
(10) Pub. No.: US 2009/0008097 A1
(43) Pub. Date: Jan. 8, 2009

(54) Externally energized constant-thrust device

(76) Inventor: Mendel Nock, Houston, TX (US)

Correspondence Address: MENDEL NOCK, 5335 GRAPE ST., HOUSTON, TX, 77096, US

(21) Appl. No.: 11/824,730

(22) Filed: Jul. 3, 2007

(51) Int. Cl. E21B 34/00; F16M 13/00

(52) U.S. Cl. 166/324; 248/571

(57) ABSTRACT

This invention is a constant-thrust device intended for use in submerged or pressured environments based on a piston-in-cylinder arrangement in which the enclosed chamber is evacuated or gas-filled to comparatively low pressure. The invention extends to boundary envelopes of general shape of which a cylinder is a simple form and to movable boundaries between pressured and unpressured spaces of which a piston is a simple form.

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

Objects are supported or held in position by a range of devices. A spring typically provides a linear response such that movement of the loaded object is proportional to the loading applied. In many cases, however, it is preferable for a uniform, or nearly uniform, force to counter the applied load. Weight and pulley systems may be used to provide constant applied load, as for instance in medical traction machines or piping supports, but such systems are cumbersome and in some locations are impractical. An extension spring, consisting of a coiled thin metal strip, is available only for small forces. The uniform load effect is sometimes approximately simulated using a gas or mechanical spring in situations in which the required stroke is small compared to the total available stroke. In the gas spring the pressure of gas in a cylinder generates the resisting force and the change in force applied is modest over the range of displacement, provided that the change in volume of contained gas does not change much during the stroke. Similarly, a preloaded spring may be used if the stroke required is small compared to the total available stroke such that the spring resistance is nearly constant within that range. In both gas and elastic springs, stroke is very limited and the thrust is not truly constant.

### BRIEF SUMMARY OF THE INVENTION

For structures or systems that are immersed in a pressured environment, the environmental fluid may be used to energize a hydraulic cylinder to develop a constant force. The external environment serves as an infinite, essentially unchanging, reservoir of fluid and pressure. The chamber formed between the cylinder and piston can be evacuated to eliminate back pressure and thus there will be no stroke-dependent force whatsoever from that side. In such case a uniform force can be guaranteed throughout the stroke and the stroke length can be as long as required.

### BRIEF DESCRIPTION OF THE SEVERAL VIEWS OF THE DRAWING

FIG. 1 shows a section through a Constant-Thrust Device arranged for constant tension.

FIG. 2 shows a section through a Constant-Thrust Device arranged for constant compression.

FIG. 3 shows a section through a Constant-Thrust Device with a valve to control access to the external pressurizing fluid.

### DETAILED DESCRIPTION OF THE INVENTION

This invention is a constant-thrust device for use in a pressured fluid environment, such as immersed in deep water. It consists of a boundary envelope, typically a cylinder, within which a piston is deployed, with a seal separating them to prevent fluid passage while allowing sliding of the piston relative to the cylinder. The enclosed chamber formed between the cylinder and piston should be evacuated, or filled with gas at a pressure very much lower than the external pressure. The opposite side of the piston is exposed to the external environmental pressure, either directly through the environmental fluid, or indirectly with the external fluid maintaining pressure on the working fluid through a bladder or other pressure transmitting arrangement.

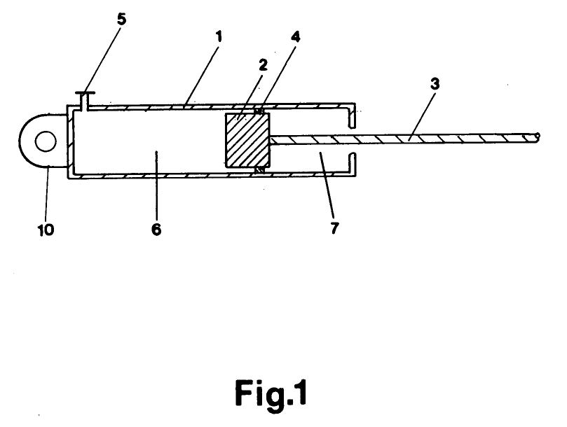

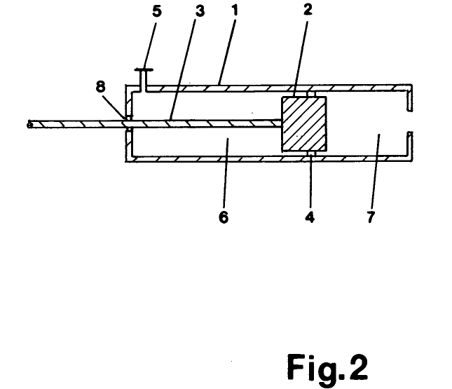

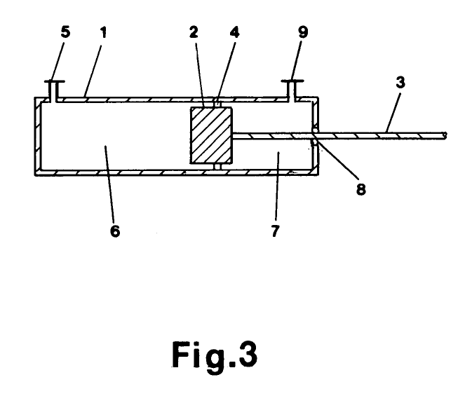

The components are:
1 cylinder
2 piston
3 rod connecting to loaded point
4 piston seal
5 evacuation port
6 evacuated or low-pressure chamber
7 fluid at external environmental pressure
8 rod seal
9 flooding port
10 cylinder structural connector to support point, shown only in FIG. 1 for clarity

Where, as in FIG. 1, the piston rod extends out from the pressured side of the piston, the device provides a constant tension. Where, as in FIG. 2, the rod attaches to the evacuated side of the piston, a constant compression is provided. As seen in FIG. 3, a second enclosed chamber can be provided on the pressured side, with the environmental fluid admitted through a valve or other controlling device to allow regulation of the occurrence of pressuring and the rate of fluid entrance.

Sealing must be provided between the piston moving relative to the cylinder, to keep the higher pressure and the evacuated or low-pressure spaces separated and to prevent leakage of fluid between the two over the life of the device. A bellows may be considered in lieu of a sliding seal to keep the two spaces separated. For the embodiment shown in FIG. 3, an additional seal is needed between the rod and the exit point through the end of the cylinder or other shape of boundary envelope.

The device is distinguished from a gas spring in that the external pressure of the environment, whether the surrounding fluid is gas or liquid, serves to provide the differential pressure. As the external environment is for practical purposes infinite in volume relative to that of the cylinder, there is no change in force due to displacement, and thus the device achieves a constant thrust. The device is distinguished from a hydraulic ram in that it is passive, based on the surrounding environmental pressure rather than active, is pressured from the rod side rather than the piston face, and provides a defined thrust rather than a controlled displacement.

For use in deep ocean applications, the high external pressure may be tapped to generate large forces, but the cylinder must be designed against hydrostatic collapse and components must be of corrosion resistant material or suitably coated. The device can also be used at low pressures, as for instance in normal atmospheric conditions, for small constant forces, with seals chosen for negligible fluid transmission with low friction.

I claim:

1. A device for applying a substantially constant force to an object, when immersed in a pressured fluid medium and utilizing the medium for driving pressure, comprising:
(a) a boundary envelope, of cylindrical or other shape, separating the pressured fluid medium external to the envelope from an evacuated or low-pressure gas-filled interior space,
(b) a piston, or other means of forming a movable boundary, deployed within the envelope between the evacuated or low-pressure interior space of said envelope and fluid on the other side of the piston that is pressured by exposure to the pressured fluid medium of the surrounding exterior environment,
(c) a rod, shaft, chain, wire, or other means for transmitting force from the piston to the loaded object to which it connects,
(d) a padeye, weld, or other means of transmitting force from the envelope to a supporting location,
(e) at each location at which there is relative movement between components exposed to pressured fluid, a means of separating the fluid exposed to the pressure of the surroundings and said evacuated or low-pressured space,
whereby the pressure difference across the movable boundary generates force between the envelope attachment point and the piston load point.

2. The constant-thrust device of claim 1, further including ports, valves or other flow passages that are a means of fluid communication for evacuating or controlling pressure in the low pressure interior space of said boundary envelope.

3. The constant-thrust device of claim 1, further including an enclosed or sealed pressured space within said boundary envelope on the pressured side of the movable boundary, and ports, valves or other flow passages that are a means of controlled fluid communication between the external environment and the pressured interior space or spaces within said boundary envelope.

4. The constant-thrust device of claim 3, further including a flexible container attached to the flow passage so that an alternate fluid may flow into the cylinder instead of that in the external environment, such that external pressure is applied throughout the fluid, and of sufficient volume such that a full stroke may be accommodated.

5. A method for applying a substantially constant force to an object, when immersed in a pressured fluid medium and utilizing the medium for driving pressure, consisting of:
(a) establishing a boundary envelope separating the pressured fluid medium external to the envelope from an evacuated or low-pressure gas-filled interior space,
(b) forming a movable boundary, within the envelope or of a region of the envelope, dividing the evacuated or low-pressure interior space of said envelope from the fluid on the other side of the movable boundary that is pressured by exposure to the pressured fluid medium of the surrounding exterior environment,
(c) linking the movable boundary to the loaded object with a means of transmitting force,
(d) linking the envelope to a supporting location with a means of transmitting the reacting force,
(e) preventing leakage of fluid between the fluid-filled space exposed to the pressure of the surroundings and said evacuated or low-pressured space,
whereby the pressure difference generates the constant force between the envelope attachment point and the movable boundary load point.

6. The method for generating constant-thrust of claim 5, further including means of fluid communication for evacuating or controlling pressure in the low pressure interior space of said boundary envelope.

7. The method for generating constant-thrust of claim 5, further including means for controlling fluid communication between the external environment and the pressured surface of said movable boundary.

8. A constant-thrust device, as a new use for a modified hydraulic ram, wherein:
(a) the chamber is either evacuated or gas-filled at a low pressure relative to the environment in which it will be deployed,
(b) the means for sealing is oriented for pressure to be applied from the outside rather than or in addition to the chamber side, and
(c) the device is placed in a pressured environment such that the normally unpressured piston face is exposed to the pressured environment,
whereby the pressure difference across the piston generates nearly uniform force between the envelope attachment point and the piston load point.

9. The constant-thrust device of claim 8, further utilizing a double-acting type hydraulic ram so that, in addition to the evacuated chamber defined in 8(a), a second chamber is formed on the opposite side of the piston with controlled access to the external environment that allows fluid exchange and therein application of pressure to the piston.
